(19) United States
(12) Patent Application Publication
(10) Pub. No.: US 2017/0329296 A1
(43) Pub. Date: Nov. 16, 2017

(54) METHOD AND APPARATUS OF PROVISIONING A MICROCONTROLLER VIA ACOUSTIC SIGNALING

(71) Applicant: Chibitronics PTE LTD, Singapore (SG)

(72) Inventors: Andrew Shane HUANG, Singapore (SG); Jie QI, New Port Richey, FL (US); Sean Cross, Singapore (SG)

(21) Appl. No.: 15/594,229

(22) Filed: May 12, 2017

Related U.S. Application Data
(60) Provisional application No. 62/335,904, filed on May 13, 2016.

(51) Int. Cl. G05B 19/042; H04B 11/00; H04L 29/08

(52) U.S. Cl. CPC G05B 19/042; H04L 67/02; H04B 11/00; G05B 2219/25257

(57) ABSTRACT

Microcontroller provisioning using acoustic signaling to provision code into on-board program storage.

### RELATED APPLICATION

This application claims priority to U.S. Provisional Application No. 62/335,904, entitled “METHOD AND APPARATUS OF PROVISIONING A MICROCONTROLLER VIA ACOUSTIC SIGNALING,” filed May 13, 2016 and is hereby incorporated by reference in its entirety.

### BACKGROUND

### Field of the Disclosure

Aspects of the disclosure relate in general to provisioning a microcontroller. Embodiments provision a microcontroller using acoustic signals.

Description of the Related Art

A typical low-cost microcontroller integrates a Central Processing Unit (CPU), program storage, temporary data storage, and a variety of peripherals, often including the ability to convert analog voltages into binary digital codes. Often referred to as a microcontroller unit (MCU) these system-on-chip platforms are ubiquitous due to their low cost and ability to implement complex, programmable functionality in a single device package.

The process of loading a user's code into on-board program storage is called “provisioning.” Program storage is often implemented using a non-volatile form of memory such as flash memory or Electrically Erasable Programmable Read-Only Memory (EEPROM).

Current methods of provisioning rely upon a digital protocol to communicate with a programming device, often referred to as the host computer. Examples of popular digital communication protocols include Joint Test Action Group (JTAG), Serial Wire Debug (SWD), Universal Serial Bus (USB), Serial Peripheral Interface Bus (SPI), and RS-232. In all of these cases, the host must have specialized drivers or programs installed to communicate with the MCU, and may require additional hardware to be installed to drive the signals. This is typically the case for JTAG and SWD, which are not standard interfaces provided on most consumer devices.

Setting up a host for provisioning an MCU can be a challenging task; a user's host computer can range from personal computers, to laptops, to smartphones and tablets, all running a different version of an operating system (OS) with markedly different hardware specifications. Professional developers have the skill and motivation to diagnose compatibility issues. However, this can present an insurmountable barrier for beginners and institutions tasked with introducing new minds to programming, especially K-12 schools which are typically less experienced in managing IT issues.

### SUMMARY

Embodiments include a method, system and apparatus that uses acoustic signaling in the microcontroller provisioning.

In one method embodiment of provisioning a microcontroller unit using acoustic signaling, a computer source code is transmitted from a web-browser to a compiler server. A web-browser computer receives a binary code from the compiler server. The binary code is a result of compiling the computer source code. The web-browser computer's processor modulates the binary code into an acoustic signal. The microcontroller unit is provisioned using the acoustic signal.

In another method embodiment of provisioning a microcontroller unit using acoustic signaling, a computer source code is transmitted from a web-browser to a compiler server. A web-browser computer receives an acoustic signal from the compiler server. The acoustic signal is a result of the compiler server: compiling the computer source code into a binary code, and modulating the binary code into the acoustic signal. The microcontroller unit is provisioned using the acoustic signal.

In another method embodiment of provisioning a microcontroller unit using acoustic signaling, receiving a plurality of a web-browser computer receives configuration options from a compiler server in a web-browser. The web-browser computer transmits to the compiler server at least one selected option from the plurality of configuration options from the web-browser. The web-browser computer receives an acoustic signal from the compiler server, the acoustic signal being a result of the compiler server receiving the at least one selected option. The microcontroller unit is provisioned using the acoustic signal.

### BRIEF DESCRIPTION OF THE DRAWINGS

The figures below illustrate a method and apparatus that uses acoustic signaling in the microcontroller provisioning.

FIG. 1 illustrates a microcontroller embodiment that may be provisioned using audio signals.

FIG. 2 is a block diagram of audio path circuitry used in the microcontroller embodiment.

FIGS. 3A-C illustrate alternate embodiments of systems to use an acoustic signal to provision a microcontroller unit with an Internet-based web-service.

FIG. 4 shows alternate embodiments of systems to use an acoustic signal to provision a microcontroller unit with an audio player.

### DETAILED DESCRIPTION

Aspects of the present disclosure include a method and apparatus that uses acoustic signaling in the microcontroller provisioning.

In order to introduce newcomers to the topic of programming, embodiments include a provisioning method that can translate code on a computer screen into binary data burned into a microcontroller unit that: (1) uses an interface available on every consumer computing device, and (2) requires no special permissions to run, or drivers to install.

Embodiments include a method for provisioning MCUs using acoustic signaling. In essence, an embodiment turns user's programs into an audio stream (a “song”), and the microcontroller can listen to the song and based on data coded into the audio stream, provision itself with the user's program.

In one embodiment, the full acoustic coupling and demodulation may be implemented using no more than one analog-input capable pin on a microcontroller and a few passive components. The cost and complexity overhead is similar to those of the incumbent digital provisioning interfaces, such as SWD or JTAG.

The acoustic modulation may be implemented in a fashion that is compatible with modern web browsers. Users do not need to install any specialized program to transmit the data; any browser capable of playing music or sound clips has the ability to provision a microcontroller using such a method embodiment. In such an embodiment, one may provision a microcontroller with nothing more than a music playing device, with the program is delivered in a format such as compact disk (CD) or flash memory drive. This level of interoperability with user hardware is unprecedented in the microcontroller unit provisioning space.

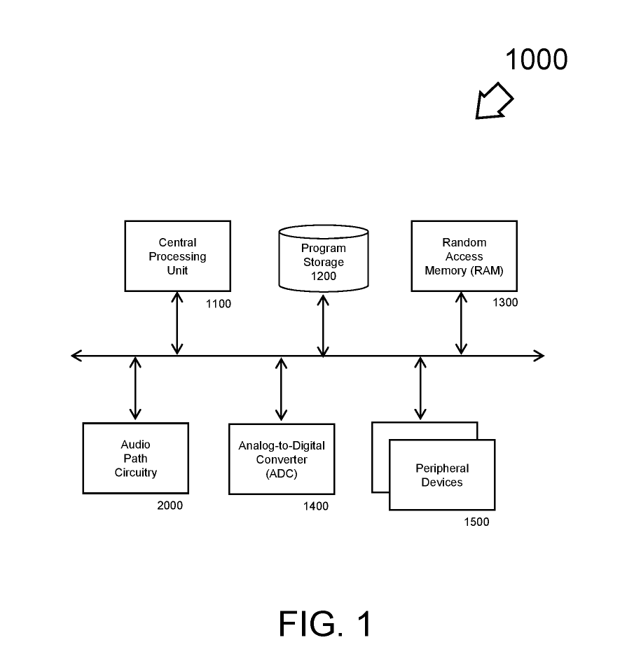

FIG. 1 depicts a microcontroller embodiment that may be provisioned using audio signals, constructed and operative in accordance with an embodiment of the disclosure. As shown in FIG. 1, a microcontroller unit 1000 comprises: a central processing unit (CPU) 1100, non-volatile but writable program storage 1200, Random Access Memory (RAM) 1300 for use as scratch space for demodulation, audio path circuitry 2000, and an analog-to-digital converter (ADC) 1400. Additionally, the microcontroller unit 1000 may also comprise peripheral devices 1500.

The central processing unit 1100 may offer over 40 MIPS of fixed-point code execution performance. In some embodiments, the CPU 1100 may be based on an Advanced RISC Machine (ARM®) Cortex®-M0+ Core manufactured by ARM Holdings plc, headquartered in Cambridge, United Kingdom.

Program storage 1200 may be flash memory or any other non-volatile but writable program storage memory.

For illustrative purposes only, a microcontroller unit 1000 embodiment may comprise: an NXP MKL02Z32VFK4 microcontroller, featuring a 48 MHz Cortex M0+ running at 48 MHz, 32k FLASH, 4 k RAM, and a 12-bit analog-to-digital converter (ADC) operating at up to 800 ksps.

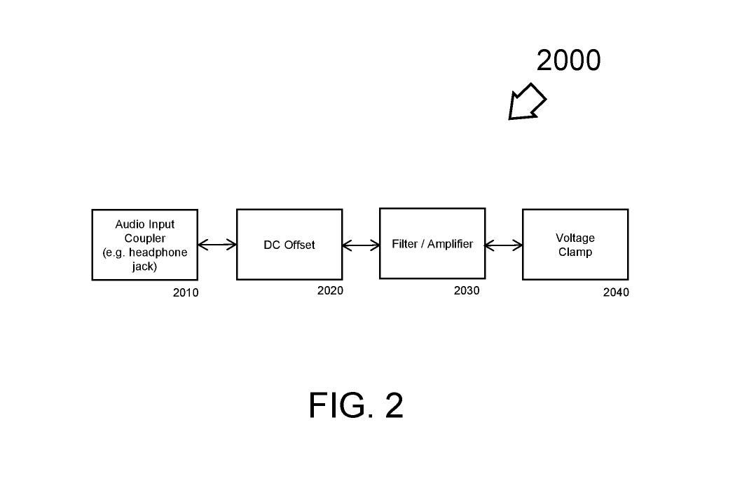

Moving to FIG. 2, the audio path circuitry 2000 is shown, constructed and operative in accordance with an embodiment of the disclosure. The microcontroller unit's analog input, as made available via the integrated analog-to-digital converter 1400, is coupled to an audio input coupler 2010. The audio input coupler 2010 may be a wired coupling, as is the case for a headphone jack embodiment, or a wireless acoustic coupling, which may be the case for a microphone embodiment. While the audio input coupler 2010 described within uses a direct headphone coupling, it is understood by those familiar with the art that the disclosure is not limited to just direct cabled audio links. In yet another embodiment, the audio input coupler 2010 may include a wireless audio link of Bluetooth peers. In yet another embodiment, the audio input coupler 2010 may include a single host playing the provisioning sounds out of a loudspeaker, and a plurality of receiving microcontrollers with microphones being configured simultaneously.

The audio input coupler 2010 may then pass through any, all or, none of a Direct Current (DC) offset correction stage 2020, a filter and/or amplification stage 2030, and a voltage clamp stage 2040, in no particular order.

If coupling to a headphone jack 2010 to a microcontroller unit 1000, a DC offset correction stage 2020 may ensure that the incoming waveform is centered in the ADC's linear input range. In one embodiment, the DC offset correction stage 2020 is a DC blocking capacitor followed by a pair of approximately equal-value resistors, with one resistor to ground and the other to the positive voltage reference of the analog-to-digital converter 1400. Furthermore a voltage clamp 2040 may be provided, comprising of a pair of diodes, one a transient voltage suppressor (TVS) which limits positive excursions, and the other a reverse biased Schottky diode, limiting negative excursions. The voltage clamp 2040 may use a DC blocking capacitor in the case that the local grounds of the audio transmitter and the MCU are offset by a large amount; at the moment of connection, the large DC offset appears as a transient pulse which can damage the MCU.

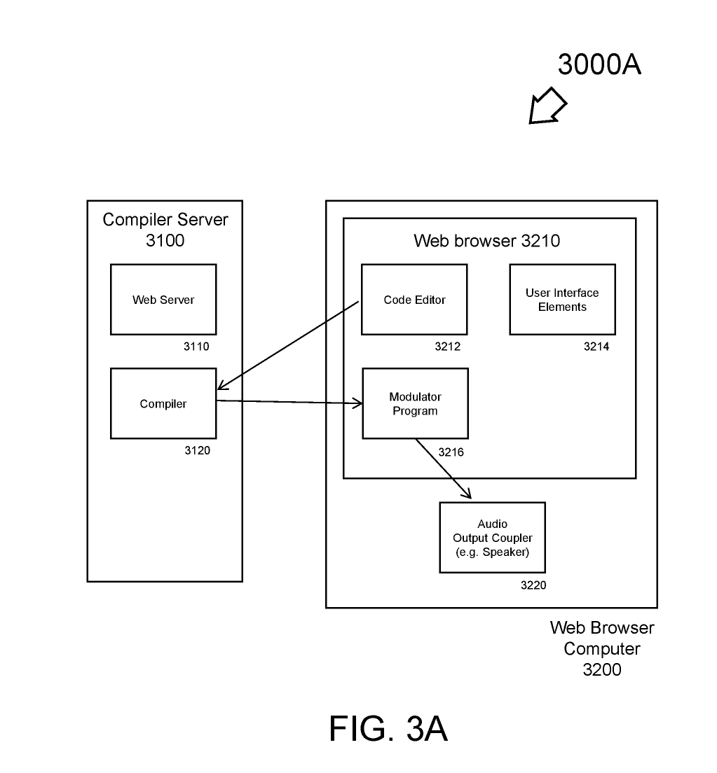

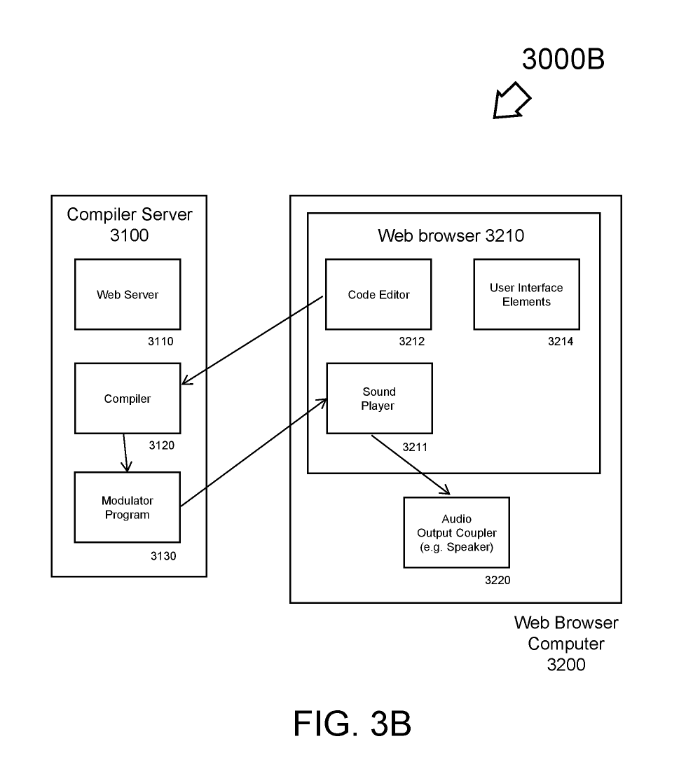

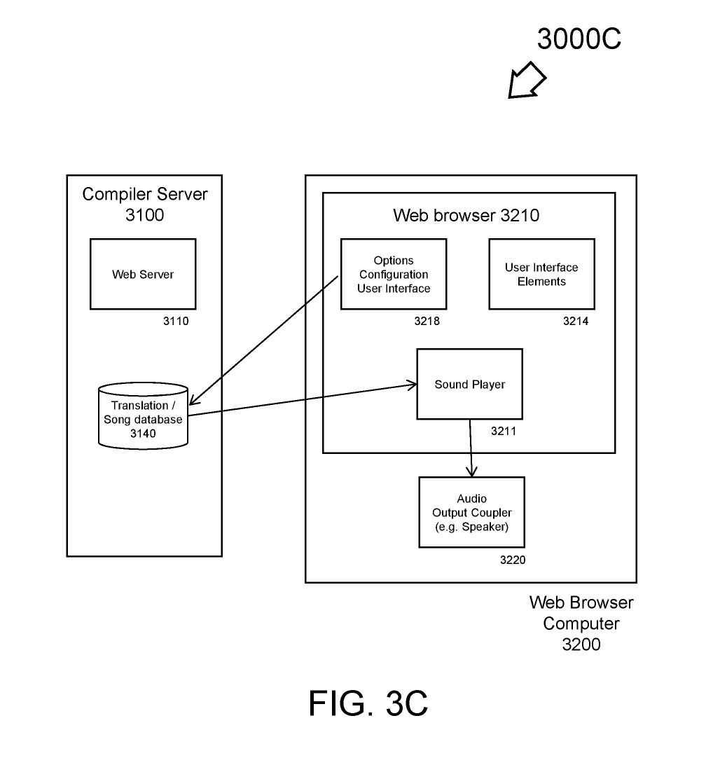

We now turn our attention to FIGS. 3A-C, which illustrate alternate embodiments of systems to use an acoustic signal to provision a microcontroller unit with an Internet-based web-service, constructed and operative in accordance with an embodiment of the disclosure. In some embodiments, a web-based method is allowed for program entry, and a web-based method is provided for translating a program into binary code. Whether a compiler is used via a server, or a compiler is used via a local JavaScript code running inside a browser, a web-based method enables communication with a compiler with no local binaries to install. In these embodiments 3000A-C, users provision an MCU 1000 using a web browser computer 3200 with a web-browser 3210 to communicate with a compiler server 3100. It is understood by one of ordinary skill in the art that the compiler server 3100 and web browser computer 3200 are each configured with a processor, computer memory, and program storage, such as non-transitory computer-readable storage media.

In FIG. 3A, compiler server 3100 may additionally comprise a web server 3110 and compiler 3120. Similarly, web browser computer may further comprise an audio output coupler 3220, such as a speaker.

In such an embodiment, web browser computer 3200 utilizes a web browser 3210, such as Google Chrome, to implement a platform-independent user interface. It is understood that a variety of user interfaces are possible; the fundamental base requirement of the user interface is the ability to play audio.

A user may edit code using an in-browser code editor 3210, using a compiler 3120 located on a compiler server 3120 to translate code into machine executable binary format, and a browser plug-in to further translate the executable into an acoustic signal suitable for MCU provisioning. In addition to the code editor 3212, the web browser 3210 may also include user interface (UI) elements 3214 and a modulator program 3216. In one embodiment, the UI elements 3214 allow the user to command the web browser 3210 to compile the code, as well as upload the compiled code to the MCU 1000 and to perform various maintenance functions such as testing the audio link quality. Furthermore, the modulator program 3216 may be a JavaScript object executed on the web browser 3210, which can translate binary files into the proper acoustic waveforms and packet formats necessary to communicate with the target MCU 1000. The audio output coupler 3220 can be any device configured to transmit audio signals to the microcontroller unit 1000, including, but not limited to: a wire, a speaker to one or more microphones, or a digital network such as Bluetooth peers.

As shown in FIG. 3A, the typical user interaction loop starts with the user editing code in the web browser 3200 using a code editor 3212, and submitting the code to the compiler server 3100 for compilation. The compiler server 3100 receives the code via its web server 3110 and uses a compiler 3120 to create a downloadable binary file. The web server 3100 return a link to a downloadable binary file by the web browser 3210. The modulator program 3130 running in the web browser 3210 downloads the binary file and translates the binary into a modulated audio stream suitable for MCU provisioning. The modulated output stream is then transformed into an audio signal and transmitted through audio output coupler 3220, be it an electrical signal sent down a wire, or an acoustic signal transmitted through air by a speaker.

Moving to FIG. 3B, some web browser 3210 or web browser computers lack 3200 performance or ability to modulate code into audio signals on the client side. In this case, provisioning system 3000B can be used, where the modulator program 3130 can be run on the server side. In such an embodiment, instead of relaying a compact machine-executable binary (or compressed binary) to the web browser 3210, an audio file is returned. In this case, the web browser computer 3200 simply plays the audio file to enable MCU provisioning. While this embodiment requires a greater bandwidth and processor load on the server side, the benefit is broader compatibility.

In another embodiment system 3000C depicted in FIG. 3C, users may wish to provision their microcontroller unit 1000, but not have to write code. In such an embodiment, instead of a code editor, users are presented with an options configuration UI 3218. Users select which options or program they wish to provision their microcontroller unit 1000, and the compiler server 3100 translates the request into a song or other audio file. The songs may also be pre-compiled and stored in a translation/song database 3140. In this embodiment, the data transmitted to the browser does not strictly need to be a song, it could also be a compact machine executable binary, if the web browser computer 3200 has the necessary compatibility and power to translate the binary into a modulated audio stream on the fly.

This embodiment is particularly useful for users who are less interested in coding but still desire some level of customization. As an example, a user may want to configure an MCU to simply flash between two different colors. Picking which color to show doesn't essentially require the ability to modify computer code; a simple UI with different buttons for different colors may suffice.

This embodiment also simplifies the sharing of programs between users. Programmers can write programs for target microcontroller units 1000 that perform various tasks useful to end users, and users can browse the offerings, select them, and download the audio files or binaries necessary to provision the microcontroller units 1000.

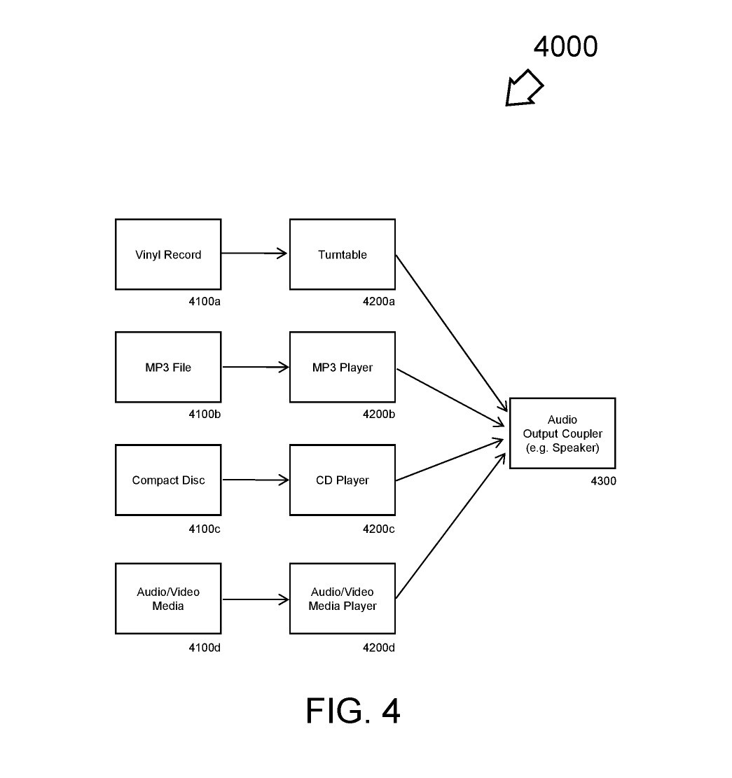

FIG. 4 shows alternate embodiments of systems 4000 to use acoustic media 4100a-d to provision a microcontroller unit 1000 with an audio player 4100a-d, constructed and operative in accordance with an embodiment of the disclosure. To emphasize the versatility of audio modulation, FIG. 4 illustrates that any type of audio media may be used to provision the microcontroller unit 1000. In such embodiments, a vinyl record 4100a, MP3 file 4100b, compact disc 4100c, or any other audio/video media 4100d may be used with a turntable 4200a, mp3 player 4200b, CD player 4200c, or audio/video media player 4200d, respectively. In such embodiments, for example, a vinyl record 4100 is cut with the modulated audio stream. The vinyl record 4100a is played on a turntable 4200a into an audio output coupler 4300. In a vinyl record 4100a embodiment, there is not a single digital part is needed in the MCU 1000 provisioning mechanism.

Audio Modulation

There are a large number of audio modulation techniques that can be used to implement the acoustic signaling, including but not limited to On-Off Keying (OOK), Frequency-Shift Keying (FSK), pulse-amplitude modulation (PAM), quadrature amplitude modulation (QAM), and orthogonal frequency-division multiplexing (OFDM).

In an example embodiment, frequency shift keying at a baud rate of 9600 baud is employed with a frequency of 10.4 kHz representing a ‘0’ and 15 kHz representing a ‘1’.

In an alternate example embodiment, frequency shift keying is run at 8000 baud, and use frequencies of 8666 Hz for ‘0’ and 12500 Hz for ‘1’, with an option to fall back to a “low bit rate” mode using frequencies of 2166.5 Hz and 3125 Hz if a pilot tone of 8666 Hz is initially heard for longer than a half second. Such an embodiment the low bit rate fallback enables functionality in situations where an audio sound card is of low fidelity.

It is understood by those familiar with the art that embodiments may use different frequencies and baud rates. Some embodiments implement a multi-baud capacity, that enables fall back to a slower rate when a channel has insufficient capacity for a higher data rate.

The web browser computer 3200 modulates data at a native sample rate, typically 48 kHz or 44.1 kHz, and the MCU 1000 oversamples the data for demodulation, exemplified by a 75 kHz rate in one embodiment. The oversampled data is then subjected to non-coherent demodulation and baud rate recovery to extract a digital data stream.

To simplify compatibility issues, the embodiments may rely only on forward data transmission; in other words, the browser can send data to the MCU 1000, but the MCU 1000 is incapable of responding to the web browser computer 3200. This is necessary because not all headphone ports integrate a microphone option, and ports that do integrate a microphone option do not use a common standard.

Any analog data link is subject to occasional bit errors, and therefore a set of error correction and control measures are necessary to ensure complete and correct transmission of data to the MCU. In the preferred embodiment, the data to be transmitted to the MCU for provisioning is first divided up into 256 byte packets. Each packet is then wrapped with a header and a footer. The header contains information indicating the packet sequence number, and the footer contains a message integrity code, typically a hash or Cyclic Redundancy Check (CRC). Every packet received that passes data integrity check is committed to program memory according to the packet sequence number. Each packet may further be protected with a forward error correcting code (FEC). Any of a large body of prior art in FEC may be applied, including, but not limited to: block codes such as Hamming codes and Reed-Solomon codes, or convolutional codes such as trellis codes. In the case that FEC is not present or fails, each audio transmission is replayed several times by the browser; assuming errors are independent and random, every packet to be transmitted is eventually properly received and provisioned into the MCU.

Any given embodiment may also require additional data packet types to be defined, such as control or test packets. In one embodiment, control packets define the overall amount of data to be transmitted, as well as unique identifiers to identify a data stream, and aggregate error control codes to confirm provisioning integrity. Control packets may be freely interleaved with data packets. Test packets are used to confirm link integrity and status. In one embodiment, feedback on link status is provided to end users via an light emitting diode (LED) connected to the MCU 1000.

It is understood by any person skill in the art that the methods described herein may be executed by a computer encoded with instructions encoded on a non-transitory computer-readable storage medium.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. A method of provisioning a microcontroller unit using acoustic signaling, comprising:
using a web-based method for entering a computer source code;
receiving a binary code from the web-based method, the binary code being a result of compiling the computer source code;
modulating the binary code into an acoustic signal;
provisioning the microcontroller unit using the acoustic signal.

2. The method of claim 1, wherein the binary code is modulated into an acoustic signal using On Off Keying (OOK), Frequency-Shift Keying (FSK), pulse-amplitude modulation (PAM), quadrature amplitude modulation (QAM), or orthogonal frequency division multiplexing (OFDM).

3. The method of claim 1, wherein the binary code is modulated into an acoustic signal using Frequency-Shift Keying (FSK) at a baud rate of 8000 baud.

4. The method of claim 2, wherein the provisioning the microcontroller unit using the acoustic signal further comprises:
transmitting the acoustic signal to the microcontroller unit with a speaker.

5. The method of claim 2, wherein the provisioning the microcontroller unit using the acoustic signal further comprises:
transmitting the acoustic signal to the microcontroller unit with a wired connection to the microcontroller unit.

6. The method of claim 2, wherein the provisioning the microcontroller unit using the acoustic signal further comprises:
transmitting the acoustic signal to the microcontroller unit with a wireless connection.

7. A method of provisioning a microcontroller unit using acoustic signaling, comprising:
transmitting a computer source code from a web-browser to a compiler server;
receiving an acoustic signal from the compiler server, the acoustic signal being a result of the compiler server:
compiling the computer source code into a binary code, and
modulating the binary code into the acoustic signal;
provisioning the microcontroller unit using the acoustic signal.

8. The method of claim 7, wherein the binary code is modulated into an acoustic signal using On Off Keying (OOK), Frequency-Shift Keying (FSK), pulse-amplitude modulation (PAM), quadrature amplitude modulation (QAM), or orthogonal frequency division multiplexing (OFDM).

9. The method of claim 7, wherein the binary code is modulated into an acoustic signal using Frequency-Shift Keying (FSK) at a baud rate of 8000 baud.

10. The method of claim 8, wherein the provisioning the microcontroller unit using the acoustic signal further comprises:
transmitting the acoustic signal to the microcontroller unit with a speaker.

11. The method of claim 8, wherein the provisioning the microcontroller unit using the acoustic signal further comprises:
transmitting the acoustic signal to the microcontroller unit with a wired connection to the microcontroller unit.

12. The method of claim 8, wherein the provisioning the microcontroller unit using the acoustic signal further comprises:
transmitting the acoustic signal to the microcontroller unit with a wireless connection.

13. A method of provisioning a microcontroller unit using acoustic signaling, comprising:
receiving a plurality of configuration options from a server in a web-browser.
transmitting to the server at least one selected option from the plurality of configuration options from the web-browser;
receiving an acoustic signal from the server, the acoustic signal being a result of the server receiving the at least one selected option;
provisioning the microcontroller unit using the acoustic signal.

14. The method of claim 13, wherein the binary code is modulated into an acoustic signal using On Off Keying (OOK), Frequency-Shift Keying (FSK), pulse-amplitude modulation (PAM), quadrature amplitude modulation (QAM), or orthogonal frequency division multiplexing (OFDM).

15. The method of claim 13, wherein the binary code is modulated into an acoustic signal using Frequency-Shift Keying (FSK) at a baud rate of 8000 baud.

16. The method of claim 14, wherein the provisioning the microcontroller unit using the acoustic signal further comprises:
transmitting the acoustic signal to the microcontroller unit with a speaker.

17. The method of claim 14, wherein the provisioning the microcontroller unit using the acoustic signal further comprises:
transmitting the acoustic signal to the microcontroller unit with a wired connection to the microcontroller unit.

18. The method of claim 14, wherein the provisioning the microcontroller unit using the acoustic signal further comprises:
transmitting the acoustic signal to the microcontroller unit with a wireless connection.
